(19) United States
(12) Patent Application Publication
(10) Pub. No.: US 2008/0234407 A1
(43) Pub. Date: Sep. 25, 2008

(54) Water-Based Inks for Ink-Jet Printing

(75) Inventors: Nobushige Tanaka, Wakayama (JP); Isao Tsuru, Wakayama (JP); Masato Hoshi, Wakayama (JP); Takehiro Tsutumi, Wakayama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KAO CORPORATION, Tokyo (JP)

(21) Appl. No.: 11/719,916

(22) PCT Filed: Nov. 18, 2005
(86) PCT No.: PCT/JP05/21620

§ 371 Date: May 22, 2007

(30) Foreign Application Priority Data
Nov. 22, 2004 (JP) 2004-337200
Aug. 5, 2005 (JP) 2005-227881

(51) Int. Cl. C09D 11/10

(52) U.S. Cl. 523/221

(57) ABSTRACT

There are provided a water-based ink for ink-jet printing which not only satisfies a high optical density but also is excellent in gloss and image clarity upon printing on a coated paper; a water dispersion used in the water-based ink; and a process for producing the water dispersion. The present invention relates to a water dispersion for ink-jet printing comprising colorant containing water-insoluble polymer particles which is obtainable by mixing at least two kinds of water-insoluble polymer particles (A) and (B) which are different in average particle size from each other, wherein said polymer particles (A) have an average particle size of 70 to 200 nm and said polymer particles (B) have an average particle size of 15 to 110 nm with the proviso that the average particle size of the polymer particles (A) is larger than that of the polymer particles (B), and a difference between the average particle sizes of the polymer particles (A) and (B) is 10 nm or more; a process for production of the water dispersion; and a water-based ink containing the water dispersion.

### FIELD OF THE INVENTION

The present invention relates to water-based inks for ink-jet printing, water dispersions used in the water-based inks, and a process for producing the water dispersions.

### BACKGROUND OF THE INVENTION

In ink-jet printing methods, droplets of ink are directly projected onto a recording medium from very fine nozzles and allowed to adhere to the recording medium, to form characters and image. The ink-jet printing methods have been rapidly spread because of their various advantages such as easiness of full coloration, low costs, capability of using ordinary paper as the recording medium, non-contact with printed images and characters, etc.

Among such printing methods, in view of enhancing the weather resistance and water resistance of printed images and characters, an ink-jet printing method utilizing an ink containing a pigment as the colorant has now come to dominate (for example, refer to WO 00/39226, JP 2004-250587A, JP 2003-138177A, JP 2003-238859A and JP 2003-335992A).

For example, WO 00/39226 discloses a water-based ink containing a pigment-containing vinyl polymer which is in the form of a graft polymer obtained from a macromer to achieve a high optical density.

Also, in JP 2004-250587A, there is disclosed a water-based ink containing two or more kinds of water dispersions which are different in kind and amount of pigment contained and kinds of polymers used from each other in order to satisfy both a high optical density and a good fixing property thereof.

In JP 2003-138177A and JP 2003-238859A, there is disclosed an ink for ink-jet printing using pigment particles having two or more peaks in a particle size distribution curve thereof.

In JP 2003-335992A, there is disclosed an ink for ink-jet printing which contains a pigment, a water-soluble organic solvent, a water-soluble resin and water wherein two kinds of pigments which are different in average particle size from each other are used to achieve both a good optical density and a good fixing property thereof.

However, these conventional water-based inks are still insufficient in optical density, and it is also required to further improve a gloss and an image clarity thereof.

### SUMMARY OF THE INVENTION

The present invention relates to water-based inks for ink-jet printing having not only a high optical density, but also excellent gloss and image clarity upon printing on coated papers, water dispersions used in the water-based inks, and a process for producing the water dispersions.

The present inventors have found that a water dispersion containing at least two kinds of colorant-containing water-insoluble polymer particles which are different in average particle size thereof from each other can be imparted with not only a sufficient optical density but also excellent gloss and image clarity.

Thus, the present invention relates to the following aspects (1) to (4):

(1) A water dispersion for ink-jet printing comprising colorant-containing water-insoluble polymer particles which is obtainable by mixing at least two kinds of water-insoluble polymer particles (A) and (B) which are different in average particle size from each other, wherein the polymer particles (A) have an average particle size of 70 to 200 nm and the polymer particles (B) have an average particle size of 15 to 110 nm with the proviso that the average particle size of the polymer particles (A) is larger than that of the polymer particles (B), and a difference between the average particle sizes of the polymer particles (A) and (B) is 10 nm or more.

(2) a water-based ink for ink-jet printing comprising the water dispersion as defined in the above (1).

(3) a process for producing a water dispersion for ink-jet printing comprising the step of mixing at least two kinds of water dispersions containing colorant-containing water-insoluble polymer particles, wherein water-insoluble polymer particles (A) contained in the first water dispersion have an average particle size of 70 to 200 nm and water-insoluble polymer particles (B) contained the second water dispersion have an average particle size of 15 to 110 nm with the proviso that the average particle size of the polymer particles (A) is larger than that of the polymer particles (B), and a difference between the average particle sizes of the polymer particles (A) and (B) is 10 nm or more.

(4) a water-based ink for ink-jet printing comprising the water dispersion produced by the process as defined in the above (3).

### DETAILED DESCRIPTION OF THE INVENTION

### (Water-Insoluble Polymer)

The water dispersion and the water-based ink according to the present invention are produced by using a water dispersion containing colorant-containing water-insoluble polymer particles in view of attaining an excellent rubbing property, a low viscosity and an excellent ejecting property thereof.

Examples of water-insoluble polymers as materials of the water-insoluble polymer particles (A) and (B) used in the present invention include water-insoluble vinyl polymers, water-insoluble ester-based polymers and water-insoluble urethane-based polymers. Among these water-insoluble polymers, preferred are water-insoluble vinyl polymers in view of a good stability of the resultant water dispersion. The term “water-insoluble polymer” used herein means such a polymer which is dissolved at 25° C. in 100 g of water in an amount of preferably 10 g or less, more preferably 5 g or less and still more preferably 1 g or less as measured after dried at 105° C. for 2 h. When the water-insoluble polymer contains a salt-forming group, the above amount of the water-insoluble polymer dissolved in water is measured after the salt-forming group is neutralized 100% with acetic acid or sodium hydroxide according to the kind of salt-forming group.

The water-insoluble polymer is preferably a water-insoluble graft polymer containing a constitutional unit derived from a macromer (b) in view of allowing the resultant water dispersion and water-based ink to exhibit a sufficient optical density and a dispersion stability. In particular, the water-insoluble polymer is more preferably a water-insoluble graft polymer which contains a main chain containing a constitutional unit derived from a salt-forming group-containing monomer (a) and a constitutional unit derived from a hydrophobic monomer (c), and a side chain containing a constitutional unit derived from the macromer (b).

The water-insoluble graft polymer is preferably a water-insoluble vinyl polymer which may be produced by copolymerizing a monomer mixture containing the salt-forming group-containing monomer (a) (hereinafter occasionally referred to merely as the “component (a)”), the macromer (b) (hereinafter occasionally referred to merely as the “component (b)”) and the hydrophobic monomer (c) (hereinafter occasionally referred to merely as the “component (c)”) (hereinafter, the mixture is occasionally referred to as merely a “monomer mixture”).

### Salt-Forming Group-Containing Monomer (a):

The component (a) is used for enhancing a dispersion stability of the resultant dispersion, etc. Examples of the salt-forming group include a carboxyl group, a sulfonic group, a phosphoric group, an amino group and an ammonium group.

The component (a) includes cationic monomers and anionic monomers. Specific examples of the component (a) include those monomers described on page 5, from column 7, line 24 to column 8, line 29 of JP 9-286939A.

Typical examples of the cationic monomers include unsaturated amine-containing monomers and unsaturated ammonium salt-containing monomers. Among these cationic monomers, preferred are N,N-dimethylaminoethyl (meth)acrylate and N—(N′,N′-dimethylaminopropyl) (meth)acrylate.

Typical examples of the anionic monomers include unsaturated carboxylic acid monomers, unsaturated sulfonic acid monomers and unsaturated phosphoric acid monomers.

Examples of the unsaturated carboxylic acid monomers include acrylic acid, methacrylic acid, crotonic acid, itaconic acid, maleic acid, fumaric acid, citraconic acid and 2-methacryloyloxymethylsuccinic acid.

Examples of the unsaturated sulfonic acid monomers include styrenesulfonic acid, 2-acrylamido-2-methylpropanesulfonic acid, 3-sulfopropyl (meth)acrylate and bis(3-sulfopropyl)itaconate.

Examples of the unsaturated phosphoric acid monomers include vinylphosphonic acid, vinyl phosphate, bis(methacryloxyethyl)phosphate, diphenyl-2-acryloyloxyethyl phosphate, diphenyl-2-methacryloyloxyethyl phosphate and dibutyl-2-acryloyloxyethyl phosphate.

Among the above anionic monomers, in view of a good dispersion stability and a good ejecting property of the resultant inks, preferred are the unsaturated carboxylic acid monomers, and more preferred are acrylic acid and methacrylic acid.

The above compounds as the component (a) may be used alone or in combination of any two or more thereof.

The component (b) is used in view of enhancing an optical density and a dispersion stability of the colorant-containing water-insoluble polymer fine particles, etc., and may be such a macromer which is a monomer containing a polymerizable unsaturated functional group at one terminal end thereof and having a number-average molecular weight of 500 to 100,000 and preferably 1,000 to 10,000.

Meanwhile, the number-average molecular weight of the component (b) may be measured by gel permeation chromatography using polystyrene as a standard substance and using tetrahydrofuran containing 50 mmol/L of acetic acid as a solvent.

Examples of the macromer as the component (b) include the below-mentioned styrene-based macromers (b-1), alkyl (meth)acrylate-based macromers (b-2), aromatic ring-containing (meth)acrylate-based macromers (b-3) and silicone-based macromers (b-4).

Styrene-Based Macromer (b-1):

The styrene-based macromer means a macromer containing a constitutional unit derived from the styrene-based monomer (hereinafter occasionally referred to merely as a “monomer (b-1)”) such as styrene, α-methyl styrene and vinyl toluene. Among these styrene-based monomers, preferred is styrene.

Examples of the styrene-based macromer include styrene homopolymers having a polymerizable functional group at one terminal end thereof, and copolymers of styrene with the other monomer which have a polymerizable functional group at one terminal end thereof. The polymerizable functional group bonded to the one terminal end is preferably an acryloyloxy group or a methacryloyloxy group. When these functional groups are copolymerized with the other components, it is possible to produce the water-insoluble graft polymer containing a constitutional unit derived from the styrene-based macromer.

Examples of the other monomer copolymerizable with styrene include (1) acrylonitrile, (2) the below-mentioned (meth)acrylates (hereinafter occasionally referred to merely as the “monomer (b-2)”), and (3) aromatic ring-containing (meth)acrylate-based monomers other than styrene (hereinafter occasionally referred to merely as the “monomer (b-3)”).

The content of the constitutional unit derived from the styrene-based monomer in the side chain or the styrene-based macromer is preferably 60% by weight or higher, more preferably 70% by weight or higher and still more preferably 90% by weight or higher in view of a good rubbing resistance.

The styrene-based macromer is commercially available, for example, from Toagosei Co., Ltd., as product names of AS-6, AS-6S, AN-6, AN-6S, HS-6, HS-6S, etc.

Alkyl(meth)acrylate-Based Macromer (b-2)

The alkyl(meth)acrylate-based macromer means such a macromer containing a constitutional unit derived from the (meth)acrylate (hereinafter referred to merely as the “monomer (b-2)”) having 1 to 22 carbon atoms and preferably 1 to 18 carbon atoms which may also have a hydroxyl group.

Specific examples of the (meth)acrylate include methyl (meth)acrylate, ethyl (meth)acrylate, (iso)propyl (meth)acrylate, 2-hydroxyethyl (meth)acrylate, (iso- or tertiary-)butyl (meth)acrylate, 2-ethylhexyl (meth)acrylate, (iso)octyl (meth)acrylate, (iso)decyl (meth)acrylate and (iso)stearyl (meth)acrylate.

The side chain containing the constitutional unit derived from the monomer (b-2) may be produced by copolymerizing the alkyl(meth)acrylate-based macromer having a polymerizable functional group at one terminal end thereof. Examples of the alkyl(meth)acrylate-based macromer include a methyl methacrylate-based macromer, a butyl acrylate-based macromer, an isobutyl methacrylate-based macromer and a lauryl methacrylate-based macromer.

These alkyl(meth)acrylate-based macromers may be homopolymers of the alkyl(meth)acrylate having a polymerizable functional group at one terminal end thereof, or copolymers of the alkyl(meth)acrylate with other monomers which have a polymerizable functional group at one terminal end thereof. The polymerizable functional group bonded to one terminal end is preferably an acryloyloxy group or a methacryloyloxy group. Examples of the other monomer copolymerizable with the alkyl(meth)acrylate include the above-mentioned styrene-based monomers (monomers (b-1)) and the below-mentioned aromatic ring-containing (meth)acrylate-based monomers other than styrene (monomer (b-3)).

In the side chain or the alkyl(meth)acrylate macromer, the content of the constitutional unit derived from the (meth)acrylate is largest, and preferably 60% by weight or higher, more preferably 70% by weight or higher and still more preferably 90% by weight or higher in view of a rubbing resistance.

Aromatic Ring-Containing (meth)acrylate-Based Macromer (b-3)

The aromatic ring-containing (meth)acrylate-based macromer means such a macromer containing a constitutional unit derived from the aromatic ring-containing (meth)acrylate as the monomer (b-3).

The aromatic ring-containing (meth)acrylate is preferably a monomer represented by the following formula (1):

CH₂═CR¹COOR² (1)

wherein R¹ is a hydrogen atom or a methyl group; and R² is a substituted or unsubstituted arylalkyl group having 7 to 22 carbon atoms or a substituted or unsubstituted aryl group having 6 to 22 carbon atoms.

Specific examples of the aromatic ring-containing (meth)acrylate include benzyl (meth)acrylate, phenyl (meth)acrylate, 2-phenylethyl (meth)acrylate, phenoxyethyl (meth)acrylate, 1-naphthyl acrylate, 2-naphthyl (meth)acrylate, phthalimidomethyl (meth)acrylate, p-nitrophenyl (meth)acrylate, 2-hydroxy-3-phenoxypropyl (meth)acrylate, 2-methacryloyloxyethyl-2-hydroxypropyl phthalate and 2-acryloyloxyethyl phthalate. Among these the aromatic ring-containing (meth)acrylates, preferred is benzyl (meth)acrylate. These the aromatic ring-containing (meth)acrylates may be used alone or in combination of any two or more thereof.

The side chain containing the constitutional unit derived from the aromatic ring-containing (meth)acrylate may be produced by copolymerizing the aromatic ring-containing (meth)acrylate-based macromer having a polymerizable functional group at one terminal end thereof.

Examples of the aromatic ring-containing (meth)acrylate-based macromer include homopolymers of the aromatic ring-containing (meth)acrylate having a polymerizable functional group at one terminal end thereof, and copolymers of the aromatic ring-containing (meth)acrylate with other monomers which have a polymerizable functional group at one terminal end thereof. The polymerizable functional group bonded to one terminal end of the macromer is preferably an acryloyloxy group or a methacryloyloxy group. Examples of the other monomers copolymerizable with the aromatic ring-containing (meth)acrylate include (1) the above-mentioned styrene-based monomers as the monomers (b-1) and (2) the (meth)acrylates as the monomer (b-2).

In the side chain or the aromatic ring-containing (meth)acrylate-based macromer, the constitutional unit derived from the aromatic ring-containing (meth)acrylate has a largest content.

Silicone-Based Macromer (b-4)

The water-insoluble graft polymer used in the present invention may further contain an organopolysiloxane chain as the side chain thereof. Such a side chain is preferably produced, for example, by copolymerizing a silicone-based macromer having a polymerizable functional group at one terminal end thereof which is represented by the following formula (2):

CH₂═C(CH₃)—COOC₃H₆—[Si(CH₃)₂—O]ₜ—Si(CH₃)₃ (2)

wherein t is a number of 8 to 40.

When the polymer used in the present invention is the water-insoluble graft polymer, the weight ratio of a main chain of the polymer to a side chain thereof [main chain/side chain] is preferably from 1/1 to 20/1, more preferably from 3/2 to 15/1 and still more preferably from 2/1 to 10/1 in view of enhancing an image clarity and a dispersion stability. Meanwhile, the weight ratio is calculated assuming that the polymerizable functional group is contained in the side chain.

Among the above macromers, the styrene-based macromers having a polymerizable functional group at one terminal end thereof are preferred in view of a high affinity to colorants and an enhanced dispersion stability.

The hydrophobic monomer as the above component (c) is used for enhancing a water resistance, a rubbing resistance, a gloss, etc. Examples of the hydrophobic monomer include alkyl (meth)acrylates, alkyl (meth)acrylamides and aromatic ring-containing monomers.

The alkyl (meth)acrylates are preferably (meth)acrylates containing an alkyl group having 1 to 22 carbon atoms. Examples of the alkyl (meth)acrylates include methyl (meth)acrylate, ethyl (meth)acrylate, (iso)propyl (meth)acrylate, (iso- or tertiary-)butyl (meth)acrylate, (iso)amyl (meth)acrylate, cyclohexyl (meth)acrylate, 2-ethylhexyl (meth)acrylate, (iso)octyl (meth)acrylate, (iso)decyl (meth)acrylate, (iso)dodecyl (meth)acrylate and (iso)stearyl (meth)acrylate.

Examples of the alkyl (meth)acrylamides include (meth)acrylamides containing an alkyl group having 1 to 22 carbon atoms such as methyl (meth)acrylamide, dimethyl (meth)acrylamide, diethyl (meth)acrylamide, dibutyl (meth)acrylamide, t-butyl (meth)acrylamide, octyl (meth)acrylamide and dodecyl (meth)acrylamide.

Examples of the aromatic ring-containing monomers include styrene-based monomers such as styrene, 2-methyl styrene and vinyl toluene; aryl esters of (meth)acrylic acid such as benzyl (meth)acrylate and phenoxyethyl (meth)acrylate; and vinyl monomers containing an aromatic hydrocarbon group having 6 to 22 carbon atoms such as ethyl vinyl benzene, 4-vinyl biphenyl, 1,1-diphenyl ethylene, vinyl naphthalene and chlorostyrene.

Meanwhile, the terms “(iso- or tertiary-)” and “(iso)” used herein mean both the structure in which the groups expressed by “iso” and “tertiary” are present, and the structure in which these groups are not present (namely, “normal”), and the term “(meth)acrylate” means acrylate, methacrylate or both thereof.

As the component (c), in view of enhancing an optical density and a rubbing resistance, there are preferably used the aromatic ring-containing monomers. Among the aromatic ring-containing monomers, more preferred are the styrene-based monomers (c-1), and still more preferred are styrene and 2-methyl styrene. The content of the component (c-1) in the component (c) is preferably from 10 to 100% by weight and more preferably from 20 to 80% by weight in view of enhancing an optical density and a rubbing resistance.

Also, as the component (c), in view of enhancing a gloss and an image clarity of the resultant water-based ink, etc., there are preferably used the aromatic ring-containing monomers. Among the aromatic ring-containing monomers, more preferred are aryl esters of (meth)acrylic acid (component (c-2)), and still more preferred are (meth)acrylates containing an arylalkyl group having 7 to 22 carbon atoms, preferably 7 to 18 carbon atoms and more preferably 7 to 12 carbon atoms, and (meth)acrylates containing an aryl group having 6 to 22 carbon atoms, preferably 6 to 18 carbon atoms and more preferably 6 to 12 carbon atoms. Specific examples of such an aromatic ring-containing monomer as the component (c) include benzyl (meth)acrylate and phenoxyethyl (meth)acrylate. The content of the component (c-2) in the component (c) is preferably from 10 to 100% by weight and more preferably from 20 to 80% by weight in view of enhancing a gloss.

The above respective components (c) may be used alone or in combination of any two or more thereof. Further, the components (c-1) and (c-2) are preferably used in combination thereof.

In the present invention, the monomer mixture containing the respective components (a), (b) and (c) preferably further contains (d) a hydroxyl-containing monomer (hereinafter occasionally referred to merely as a “component (d)”).

The component (d) exhibits an excellent effect of enhancing the dispersion stability of the resultant dispersion. Examples of the component (d) include 2-hydroxyethyl (meth)acrylate, 3-hydroxypropyl (meth)acrylate, polyethylene glycol (n=2 to 30 wherein n represents an average molar number of addition of oxyalkylene groups: this definition is similarly applied to the subsequent descriptions) (meth)acrylate, polypropylene glycol (n=2 to 30) (meth)acrylate and poly(ethylene glycol (n=1 to 15)/propylene glycol (n=1 to 15) (meth)acrylate. Among these components (d), preferred are 2-hydroxyethyl (meth)acrylate, polyethylene glycol monomethacrylate and polypropylene glycol methacrylate.

The monomer mixture may further contain (e) a monomer (hereinafter occasionally referred to merely as a “component (e)”) represented by the following general formula (3):

CH₂═C(R³)COO(R⁴O)ₚR⁵ (3)

wherein R³ is a hydrogen atom or an alkyl group having 1 to 5 carbon atoms; R⁴ is a divalent hydrocarbon group having 1 to 30 carbon atoms which may contain a hetero atom; R⁵ is a monovalent hydrocarbon group having 1 to 30 carbon atoms which may contain a hetero atom; and p represents an average molar number of addition, and is a number from 1 to 60 and preferably a number from 1 to 30.

The component (e) exhibits an excellent effect of enhancing an ejecting property of the resultant water-based ink and preventing occurrence of slippage even upon continuous printing.

In the general formula (3), examples of the hetero atom which may be contained in R⁴ and R⁵ groups include a nitrogen atom, an oxygen atom, a halogen atom and a sulfur atom.

Typical examples of the groups represented by R⁴ and R⁵ include an aromatic group having 6 to 30 carbon atoms, a heterocyclic group having 3 to 30 carbon atoms, and an alkylene group having 1 to 30 carbon atoms. These groups may have a substituent group, and may be used in combination of any two or more thereof. Examples of the substituent group include an aromatic group, a heterocyclic group, an alkyl group, a halogen atom and an amino group.

Examples of the groups represented by R⁴ include a substituted or unsubstituted phenylene group having 1 to 24 carbon atoms, an aliphatic alkylene group having 1 to 30 carbon atoms and preferably 1 to 20 carbon atoms, an aromatic ring-containing alkylene group having 7 to 30 carbon atoms, and a hetero ring-containing alkylene group having 4 to 30 carbon atoms. Specific examples of the preferred R⁴⁰ group include an oxymethylene group, an oxy(iso)propylene group, an oxytetramethylene group, an oxyheptamethylene group, an oxyhexamethylene group, and oxyalkylene or oxyphenylene groups having 2 to 7 carbon atoms which are each constituted from at least one of these oxyalkylene groups.

Examples of the groups represented by R⁵ include a phenyl group, a branched or unbranched aliphatic alkyl group having 1 to 30 carbon atoms and preferably 1 to 20 carbon atoms, an aromatic ring-containing alkyl group having 7 to 30 carbon atoms, and a hetero ring-containing alkyl group having 4 to 30 carbon atoms. Examples of the preferred R⁵ group include an alkyl group having 1 to 12 carbon atoms such as methyl, ethyl, (iso)propyl, (iso)butyl, (iso)pentyl and (iso)hexyl, and a phenyl group.

Specific examples of the component (e) include methoxy polyethylene glycol (p in the general formula (3): 1 to 30; this is similarly applied to the subsequent descriptions) (meth)acrylate, methoxy polytetramethylene glycol (p=1 to 30) (meth)acrylate, ethoxy polyethylene glycol (p=1 to 30) (meth)acrylate, (iso)propoxy polyethylene glycol (p=1 to 30) (meth)acrylate, butoxy polyethylene glycol (p=1 to 30) (meth)acrylate, octoxy polyethylene glycol (p=1 to 30) (meth)acrylate, methoxy polypropylene glycol (p=1 to 30) (meth)acrylate, and methoxy (ethylene glycol/propylene glycol copolymer) (p=1 to 30: among which the number of ethylene glycol constitutional units is 1 to 29) (meth)acrylate. Among these compounds, preferred is methoxy polyethylene glycol (p=1 to 30) (meth)acrylate.

Specific examples of the commercially available components (d) and (e) include polyfunctional acrylate monomers (NK Esters) available from Shin-Nakamura Kagaku Kogyo Co., Ltd., such as “M-40G”, “M-90G” and “M-230G”; and BLEMMER Series available from NOF Corporation, such as “PE-90”, “PE-200”, “PE-350”, “PME-100”, “PME-200”, “PME-400”, “PME-1000”, “PP-1000”, “PP-500”, “PP-800”, “AP-150”, “AP-400”, “AP-550”, “AP-800”, “50PEP-300” and “50POEP-800B”.

These components (d) and (e) are respectively used alone or in the form of a mixture of any two or more thereof.

The respective contents of the above components (a) to (e) in the monomer mixture are as follows.

The content of the component (a) is preferably from 1 to 50% by weight, more preferably from 2 to 40% by weight and still more preferably from 3 to 20% by weight in view of a good dispersion stability of the resultant dispersion, etc.

The content of the component (b) is preferably from 1 to 50% by weight and more preferably from 5 to 40% by weight in view of an optical density and a good dispersion stability of the colorant-containing water-insoluble polymer fine particles.

The content of the component (c) is preferably from 5 to 98% by weight and more preferably from 10 to 60% by weight in view of enhancing a water resistance, a rubbing resistance, an optical density, an image clarity and a gloss.

The weight ratio of the component (a) to a sum of the components (b) and (c) ((a)/[(b)+(c)]) is preferably from 0.01 to 1, more preferably from 0.02 to 0.67 and still more preferably from 0.03 to 0.50 in view of a good long-term storage stability and a good ejecting property of the resultant water-based ink, etc.

The content of the component (d) is preferably from 5 to 40% by weight and more preferably from 7 to 30% by weight in view of a good ejecting property and a good dispersion stability.

The content of the component (e) is preferably from 5 to 50% by weight and more preferably from 10 to 40% by weight in view of a good ejecting property, a good dispersion stability, etc.

The total content of the components (a) and (d) in the monomer mixture is preferably from 6 to 60% by weight and more preferably from 10 to 50% by weight in view of a good stability and a good water resistance in water, etc.

The total content of the components (a) and (e) in the monomer mixture is preferably from 6 to 75% by weight and more preferably from 13 to 50% by weight in view of a good dispersion stability in water and a good ejecting property, etc.

The total content of the components (a), (d) and (e) in the monomer mixture is preferably from 6 to 60% by weight and more preferably from 7 to 50% by weight in view of a good dispersion stability in water, a good ejecting property, etc.

The water-insoluble polymer constituting the water-insoluble polymer particles used in the present invention may be produced by copolymerizing the monomer mixture by known methods such as bulk polymerization, solution polymerization, suspension polymerization and emulsion polymerization. Among these polymerization methods, the solution polymerization is preferred since the effects of the present invention such as high optical density and high image clarity are suitably attained by the method.

The solvent for the solution polymerization method is preferably an organic polar solvent having a high affinity to the water-insoluble polymer. The organic polar solvent preferably has a solubility in water of from 5 to 50% by weight as measured at 20° C. Examples of the organic polar solvents include aliphatic alcohols such as butoxyethanol; aromatic hydrocarbons such as toluene and xylene; ketones such as methyl ethyl ketone and methyl isobutyl ketone; and esters such as ethyl acetate. Among these solvents, preferred are methyl ethyl ketone, methyl isobutyl ketone, toluene, xylene, butoxyethanol, and mixed solvents of at least one thereof with water.

The polymerization may be carried out in the presence of a conventionally known radical polymerization initiator, e.g., azo compounds such as 2,2′-azobisisobutyronitrile and 2,2′-azobis(2,4-dimethylvaleronitrile), and organic peroxides such as t-butyl peroxyoctoate and dibenzoyl oxide. The amount of the radical polymerization initiator to be used is preferably from 0.001 to 5 mol and preferably from 0.01 to 2 mol per 1 mol of the monomer mixture. The polymerization may also be carried out in the presence of a conventionally known chain transfer agent, e.g., mercaptans such as octyl mercaptan and 2-mercaptoethanol, and thiuram disulfides.

The polymerization conditions of the monomer mixture vary depending upon the kinds of radical polymerization initiators, monomers, solvents, etc., to be used, and the polymerization is generally conducted at a temperature of preferably 30 to 100° C. and more preferably 50 to 80° C. The polymerization time is preferably from 1 to 20 h. The polymerization is preferably conducted in an atmosphere of an inert gas such as nitrogen and argon.

After completion of the polymerization, the polymer thus produced is isolated from the reaction solution by a known method such as reprecipitation and removal of solvent by distillation. The thus obtained polymer may be purified by repeated reprecipitation, membrane separation, chromatography, extraction, etc., for removing unreacted monomers, etc.

The weight-average molecular weight of the resultant water-insoluble polymer is preferably from 5,000 to 500,000, more preferably from 10,000 to 400,000 and still more preferably from 10,000 to 300,000 in view of a good dispersion stability of the colorant, a good water resistance and a good ejecting property.

Meanwhile, the weight-average molecular weight of the polymer may be measured by gel chromatography using dimethylformamide containing 60 mmol/L of phosphoric acid and 50 mmol/L of lithium bromide as a solvent and using polystyrene as a standard substance.

The solution of the water-insoluble polymer preferably has a solid content of 3 to 30%, more preferably 5 to 20% and most preferably 10 to 15%.

When the water-insoluble polymer used in the present invention contains a salt-forming group derived from the salt-forming group-containing monomer (a), the salt-forming group is neutralized with a neutralizing agent. As the neutralizing agent, acids or bases may be used according to the kind of the salt-forming group in the water-insoluble polymer. Examples of the neutralizing agent include acids such as hydrochloric acid, acetic acid, propionic acid, phosphoric acid, sulfuric acid, lactic acid, succinic acid, glycolic acid, gluconic acid and glyceric acid, and bases such as lithium hydroxide, sodium hydroxide, potassium hydroxide, ammonia, methylamine, dimethylamine, trimethylamine, ethylamine, diethylamine, triethylamine, triethanolamine and tributylamine.

The degree of neutralization of the water-insoluble polymer is usually from 10 to 200%, preferably from 20 to 150% and more preferably from 50 to 150%.

When the salt-forming group is an anionic group, the degree of neutralization thereof is calculated according to the following formula:

[weight (g) of neutralizing agent)/equivalent of neutralizing agent]/[acid value of polymer (KOH mg/g)×weight (g) of polymer/(56×1000)]×100

When the salt-forming group is a cationic group, the degree of neutralization thereof is calculated according to the following formula:

[weight (g) of neutralizing agent)/equivalent of neutralizing agent]/[amine value of polymer (HCl mg/g)×weight (g) of polymer/(36.5×1000)]×100

The acid value or amine value may be calculated from the respective constitutional units of the water-insoluble vinyl polymer, or may also be determined by the method of subjecting a solution prepared by dissolving the polymer in an appropriate solvent such as methyl ethyl ketone to titration.

### Colorant

The colorant used in the water dispersion of the present invention is not particularly limited, and there may be used any of pigment, hydrophobic dye, and water-soluble dye such as acid dye, reactive dye and direct dye. The colorant used in the present invention is preferably pigment or hydrophobic dye in view of a good water resistance thereof. Among these colorants, to meet the recent strong demand for a high weather resistance, preferred is the pigment.

The pigment or hydrophobic dye used in the water-based ink is preferably finely divided into stable fine particles using a surfactant or a water-insoluble polymer. In particular, in view of a good bleeding resistance and a good water resistance, the pigment and/or hydrophobic dye used in the present invention is preferably included in particles of the water-insoluble polymer.

The pigment may be either organic or inorganic. The organic or inorganic pigment may be used in combination with an extender pigment, if required.

Examples of the inorganic pigments include carbon blacks, metal oxides, metal sulfides and metal chlorides. Among these inorganic pigments, carbon blacks are preferably used for black water-based inks. The carbon blacks may include furnace blacks, thermal lamp blacks, acetylene blacks and channel blacks.

Examples of the organic pigments include azo pigments, disazo pigments, phthalocyanine pigments, quinacridone pigments, isoindolinone pigments, dioxazine pigments, perylene pigments, perinone pigments, thioindigo pigments, anthraquinone pigments and quinophthalone pigments.

The hue of the colorant usable in the present invention is not particularly limited. In the present invention, there may be used chromatic pigments such as red organic pigments, yellow organic pigments, blue organic pigments, orange organic pigments and green-orange organic pigments.

In the present invention, since the at least two kinds of polymer particles which are different in average particle size from each other, i.e., the polymer particles (A) and (B), are used, the polymer particles contained in the water-based ink ejected from ink-jet nozzles can be improved in a filling efficiency thereof on prints. As a result, it is considered that even when using the chromatic pigment, the resultant images are excellent in color gloss and image clarity as well as image definition.

Specific examples of the preferred organic pigments include those pigments having product numbers of C.I. Pigment Yellow 13, 17, 74, 83, 97, 109, 110, 120, 128, 139, 151, 154, 155, 174, 180; C.I. Pigment Red 48, 57:1, 122, 146, 176, 184, 185, 188, 202; C.I. Pigment Violet 19, 23; C.I. Pigment Blue 15, 15:1, 15:2, 15:3, 15:4, 16, 60; and C.I. Pigment Green 7, 36.

Examples of the extender pigment include silica, calcium carbonate and talc.

The hydrophobic dyes are not particularly limited as long as they are capable of being included in the water-insoluble polymer particles. To allow the dye to efficiently become included in the water-insoluble polymer, the solubility of the hydrophobic dye is preferably 2 g/L or more and more preferably from 20 to 500 g/L as measured at 25° C. on the basis of the organic solvent used upon the production of the water-insoluble polymer, such as preferably methyl ethyl ketone.

Examples of the hydrophobic dyes include oil dyes and disperse dyes. Among these dyes, preferred are oil dyes.

Examples of the oil dyes include C.I. Solvent Black 3, 7, 27, 29, 34, 45; C.I. Solvent Yellow 14, 16, 29, 56, 82, 83:1; C.I. Solvent Red 1, 3, 8, 18, 24, 27, 43, 49, 51, 72, 73; C.I. Solvent Violet 3; C.I. Solvent Blue 2, 4, 11, 44, 64, 70; C.I. Solvent Green 3, 7; and C.I. Solvent Orange 2.

Examples of the disperse dyes include C.I. Disperse Yellow 5, 42, 54, 64, 79, 82, 83, 93, 99, 100, 119, 122, 124, 126, 160, 184:1, 186, 198, 199, 204, 224, 237; C.I. Disperse Orange 13, 29, 31:1, 33, 49, 54, 55, 66, 73, 118, 119, 163; C.I. Disperse Red 54, 60, 72, 73, 86, 88, 91, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356, 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365, 368; and C.I. Disperse Green 6:1, 9.

Among these dyes, preferred are C.I. Solvent Yellow 29 and 30 for yellow colorant, C.I. Solvent Blue 70 for cyan colorant, C.I. Solvent Red 18 and 49 for magenta colorant, and C.I. Solvent Black 3 and 7 and nigrosine black dyes for black colorant.

The above colorants may be used alone or in combination of any two or more thereof.

To enhance the dispersion stability and optical density, the content of the colorant in the water dispersion and water-based ink of the present invention is preferably from 1 to 30% by weight, more preferably from 2 to 20% by weight and still more preferably from 2 to 10% by weight.

To enhance the optical density, the amounts of the water-insoluble polymer and the colorant used in the present invention are adjusted such that the weight ratio [the colorant/the water-insoluble polymer] of the colorant to the water-insoluble polymer is preferably from 50/50 to 90/10 and more preferably from 50/50 to 80/20.

### (Water-Insoluble Organic Compound)

The water dispersion for ink-jet printing and the water-based ink of the present invention preferably contains a water-insoluble organic compound in view of enhancing a gloss and an image clarity. It is considered that the water-insoluble organic compound serves for enhancing a smoothness of the colorant-containing water-insoluble polymer particles on the printed surface, resulting in improvement in gloss and image clarity of the resultant prints.

The weight ratio [the water-insoluble organic compound/the water-insoluble polymer] of the water-insoluble organic compound to the water-insoluble polymer is preferably from 1/100 to 5/1, more preferably from 1/50 to 2/1, still more preferably from 1/50 to 1/1, further still more preferably from 1/30 to 1/1 and most preferably from 1/10 to 1/1 in view of enhancing a gloss and an image clarity.

The content of the water-insoluble organic compound in the water dispersion or the water-based ink of the present invention is preferably from 0.11 to 10% by weight, more preferably from 0.15 to 5% by weight and most preferably from 0.2 to 3% by weight in view of enhancing an image clarity and a gloss.

The water-insoluble organic compound preferably has a molecular weight of from 100 to 2,000 and more preferably from 100 to 1,000 in view of enhancing a gloss and an image clarity of the resultant ink.

The solubility of the water-insoluble organic compound in water is 5 g or lower, preferably 3 g or lower and more preferably 1 g or lower per 100 g of water as measured at 20° C.

The water-insoluble organic compound preferably has a Log P value of from −1 to 11, more preferably from 1 to 9, still more preferably from 1.5 to 8 and most preferably from 2 to 7 for enhancing a flexibility of the polymer.

Here, the “Log value” means a logarithm of a 1-octanol/water partition coefficient of the water-insoluble organic compound, and is expressed by a numerical value calculated according to fragment approach using SRC's LOGKOW/KOWWIN Program of KowWin (Syracuso Research Corporation, USA) (The KowWin Program methodology is described in the following journal article: Meylan, W. M. and P. H. Howard, 1995, “Atom/fragment contribution method for estimating octanol-water partition coefficients”, J. Parm. Sci., 84, pp. 83-92). The fragment approach is conducted on the basis of a chemical structure of compounds in which the number of atoms and the type of chemical bonds are taken into consideration. The Log P value is in general a numerical value which is used for relative evaluation of hydrophilic and hydrophobic properties of organic compounds.

The water-insoluble organic compound is more preferably in the form of an ester compound, an ether compound or an amide compound for facilitating inclusion of the water-insoluble organic compound in the water-insoluble polymer particles. The water-insoluble organic compound is more preferably an ester or ether compound (A) containing two or more ester or ether bonds in a molecule thereof, or an ester or ether compound (B) containing one or more ester or ether bonds and at least one functional group selected from the group consisting of a carboxylic acid residue, a sulfonic acid residue, a phosphoric acid residue, an epoxy group and a hydroxyl group in a molecule thereof.

The number of the ester or ether bonds in the compound (A) is preferably from 2 to 3; the number of the ester or ether bonds in the compound (B) is preferably from 1 to 3, and the number of the functional groups in the compound (B) is preferably from 1 to 3.

Among these ester or ether compounds, preferred are esters produced from a monovalent carboxylic acid or a salt thereof, and a polyvalent alcohol; esters produced from a polyvalent acid such as polycarboxylic acid and phosphoric acid or a salt thereof, and a monovalent alcohol; and ethers of polyvalent alcohols, and more preferred are those compounds having two aliphatic or aromatic carboxylic ester groups or three phosphoric ester groups. Examples of the salt include alkali metal salts, alkanol amine salts and ammonium salts.

Examples of the monovalent carboxylic acid include linear or branched aliphatic carboxylic acids having 1 to 18 carbon atoms and preferably 2 to 10 carbon atoms, for example, linear aliphatic carboxylic acids such as acetic acid, butyric acid, caproic acid, caprylic acid, capric acid, lauric acid and palmitic acid, branched aliphatic carboxylic acids such as pivalic acid, and unsaturated aliphatic carboxylic acids such as acrylic acid and methacrylic acid; and aromatic carboxylic acids having 6 to 12 carbon atoms such as benzoic acid. Examples of the polyvalent acid include aliphatic carboxylic acids having 2 to 12 carbon atoms such as maleic acid, fumaric acid, itaconic acid, succinic acid, adipic acid and sebacic acid; aromatic carboxylic acids having 6 to 12 carbon atoms such as phthalic acid and trimellitic acid; and phosphoric acids.

Examples of the monovalent alcohol include linear or branched aliphatic alcohols having 1 to 18 carbon atoms and preferably 2 to 10 carbon atoms such as ethyl alcohol, butyl alcohol, hexyl alcohol, octyl alcohol, decyl alcohol and dodecyl alcohol; and aromatic alcohols having 6 to 12 carbon atoms such as phenol. Examples of the polyvalent alcohol include those having 2 to 12 carbon atoms such as ethylene glycol, diethylene glycol, neopentyl glycol, trimethylol propane, pentaerythritol and glycerol. The aliphatic acids and alcohols used in the present invention may be either saturated or unsaturated.

Specific examples of the water-insoluble organic compound include aliphatic carboxylic esters, aromatic di- or tri-carboxylic esters, phosphoric esters, cycloalkane (cycloalkene) carboxylic esters, oxyacid esters, glycol esters, epoxy-based esters, sulfonamides, polyesters, glyceryl alkyl ethers, glyceryl alkyl esters, glycol alkyl ethers, glycol alkyl esters, ethers or esters of trimethylol propane, and ethers or esters of pentaerythritol. Among these compounds, preferred is at least one compound selected from the group consisting of aliphatic dicarboxylic esters, aromatic di- or tri-carboxylic esters and phosphoric esters.

Specific examples of the preferred aliphatic dicarboxylic ester include diesters of aliphatic dibasic acids having 6 to 10 carbon atoms such as diethyl adipate, dibutyl adipate, diisobutyl adipate, bis(butyl diglycol) adipate, diethyl sebacate, dibutyl sebacate and diisobutyl sebacate.

Specific examples of the preferred aromatic di- or tri-carboxylic esters include phthalic diesters containing an aliphatic alcohol residue having 1 to 5 carbon atoms such as dimethyl phthalate, diethyl phthalate, di-n-butyl phthalate and diisobutyl phthalate; benzyl phthalates containing an alkyl group having 3 to 18 carbon atoms such as octylbenzyl phthalate and stearylbenzyl phthalate; and trimellitic diesters containing an aliphatic alcohol residue having 3 to 5 carbon atoms such as dibutyl trimellitate and diisobutyl trimellitate.

Specific examples of the phosphoric esters include phosphoric esters containing an alkoxyalkyl group having 5 to 9 carbon atoms such as tris(butoxyethyl) phosphate; phosphoric esters containing an aliphatic hydrocarbon group having 4 to 12 carbon atoms such as tributyl phosphate; and phosphoric esters containing an aromatic hydrocarbon group having 7 to 12 carbon atoms such as tris(butoxyethyl) phosphate, tricresyl phosphate, trixylenyl phosphate and cresyldiphenyl phosphate. The phosphoric esters are preferably in the form of a phosphoric di- or tri-ester.

### Process for Production of Water Dispersion

The water dispersion of the colorant-containing water-insoluble polymer particles (A) and (B) is preferably produced through the following steps (1) and (2):

Step (1): Dispersing a mixture containing the water-insoluble polymer, organic solvent, colorant and water as well as neutralizing agent, if required.

Step (2): Removing the organic solvent from the resultant dispersion.

In the step (1), first, preferably, the water-insoluble polymer is dissolved in an organic solvent, and then the colorant and water together with optional components such as neutralizing agent and surfactant, if required, are added and mixed in the resultant organic solvent solution to obtain a dispersion of an oil-in-water type. The content of the colorant in the mixture is preferably from 5 to 50% by weight. The content of the organic solvent in the mixture is preferably from 10 to 70% by weight. The content of the water-insoluble polymer in the mixture is preferably from 2 to 40% by weight, and the content of water in the mixture is preferably from 10 to 70% by weight. The water-insoluble polymer containing a salt-forming group is preferably neutralized with a neutralizing agent. The degree of neutralization of the salt-forming group in the polymer is not particularly limited. In general, the degree of neutralization is preferably controlled such that the finally obtained water dispersion exhibits a neutral liquid property, for example, a pH of 4.5 to 10. The pH of the dispersion may also be determined from a desired degree of neutralization for the water-insoluble polymer.

Examples of the preferred organic solvents include alcohol solvents, ketone solvents and ether solvents, i.e., the organic solvents are preferably those having a solubility in water of 50% by weight or lower but 10% by weight or higher as measured at 20° C.

Examples of the alcohol solvents include ethanol, isopropanol, n-butanol, tertiary butanol, isobutanol and diacetone alcohol. Examples of the ketone solvents include acetone, methyl ethyl ketone, diethyl ketone and methyl isobutyl ketone. Examples of the ether solvents include dibutyl ether, tetrahydrofuran and dioxane. Among these solvents, preferred are isopropanol, acetone and methyl ethyl ketone, and more preferred is methyl ethyl ketone. These solvents may be used alone or in the form of a mixture of any two or more thereof.

As the neutralizing agent, acids or bases may be selectively used according to the kind of salt-forming group contained in the water-insoluble polymer.

Specific examples of the neutralizing agent include acids such as hydrochloric acid, acetic acid, propionic acid, phosphoric acid, sulfuric acid, lactic acid, succinic acid, glycolic acid, gluconic acid and glyceric acid, and bases such as lithium hydroxide, sodium hydroxide, potassium hydroxide, ammonia, methylamine, dimethylamine, trimethylamine, ethylamine, diethylamine, triethylamine and triethanolamine.

The method for dispersing the mixture used in the step (1) is not particularly limited. Preferably, the mixture is first subjected to preliminary dispersion procedure, and then to the substantial dispersion procedure by applying a shear stress thereto. In the step (2), the solids contained in the dispersion are finely divided so as to produce the water-insoluble polymer particles having a desired average particle size.

Upon subjecting the mixture to the preliminary dispersion procedure, there may be used ordinary mixing or stirring devices such as anchor blades. Examples of the preferred mixing or stirring devices include high-speed mixers or stirrers such as “Ultra Disper” (tradename: available from Asada Tekko Co., Ltd.), “Ebara Milder” (tradename: available from Ebara Seisakusho Co., Ltd.), “TK Homomixer”, “TK Pipeline Mixer”, “TK Homo Jetter”, “TK Homomic Line Flow” and “Filmix” (tradenames: all available from Tokushu Kika Kogyo Co., Ltd.), “Clearmix” (tradename: available from M-Technic Co., Ltd.) and “K. D. Mill” (tradename: available from Kinetics Dispersion Inc.).

To apply the shear stress to the mixture in the substantial dispersion procedure, there may be used, for example, kneading machines such as roll mills, beads mills, kneaders and extruders, homo-valve-type high-pressure homogenizers such as typically “High-Pressure Homogenizer” (tradename: available from Izumi Food Machinery Co., Ltd.) and “Mini-Labo 8.3H Model” (tradename: available from Rannie Corp.), and chamber-type high-pressure homogenizers such as “Micro Fluidizer” (tradename: available from Microfluidics Inc.), “Nanomizer” (tradename: available from Nanomizer Co., Ltd.), “Altimizer” (tradename: available from Sugino Machine Co., Ltd.), “Genus PY” (tradename: available from Hakusui Kagaku Co., Ltd.) and “DeBEE 2000” (tradename: Nippon BEE Co., Ltd.). Among these apparatuses, the high-pressure homogenizers are preferred in view of reducing a particle size of the pigment contained in the mixture.

In the step (2), the organic solvent is removed by distillation from the dispersion thus obtained in the above step (1) to render the dispersion aqueous or water-based and thereby obtain a water dispersion of the colorant-containing water-insoluble polymer particles having a desired average particle size. The removal of the organic solvent from the water dispersion may be performed by an ordinary method such as distillation under reduced pressure. The organic solvent is substantially completely removed from the thus obtained water dispersion of the water-insoluble polymer particles. The content of the residual organic solvent in the water dispersion is usually 0.1% by weight or lower and preferably 0.01% by weight or lower. Further, the thus obtained water dispersion of the water-insoluble polymer particles may be classified by centrifugal separation in order to obtain the colorant-containing polymer particles having a desired particle size. The water dispersion of the water-insoluble polymer particles is preferably passed through a filter to remove coarse particles therefrom. Although such coarse particles are usually not present or present only in a small amount, in order to prevent clogging of nozzles in a printer, the mesh size of the filter is preferably from 1 to 10 μm and more preferably from 3 to 7 μm.

In the above water dispersion of the colorant-containing water-insoluble polymer particles, solid components made of the colorant-containing water-insoluble polymer are dispersed in water as a main solvent. The configuration of the colorant-containing water-insoluble polymer particles is not particularly limited as long as the particles are formed from at least the colorant and the water-insoluble polymer. Examples of the configuration of the particles include the particle configuration in which the colorant is enclosed in the respective water-insoluble polymer particles, the particle configuration in which the colorant is uniformly dispersed in the respective water-insoluble polymer particles, and the particle configuration in which the colorant is exposed onto a surface of the respective water-insoluble polymer particles.

### (Water Dispersion Containing Two or More Kinds of Water-Insoluble Polymer Particles, and Water-Based Ink)

The colorant-containing water-insoluble polymer particles contained in the water dispersion of the present invention include two or more kinds of water-insoluble polymer particles which are different in average particle size from each other, e.g., the colorant-containing water-insoluble polymer particles may be obtainable by mixing the water-insoluble polymer particles (A) (hereinafter referred to merely as “polymer particles (A)”) and the water-insoluble polymer particles (B) (hereinafter referred to merely as “polymer particles (B)”) with each other. Also, the colorant-containing water-insoluble polymer particles may be made of three, four or more kinds of water-insoluble polymer particles which are different in average particle size from each other. The use of the polymer particles (A) and (B) having different average particles sizes from each other will enable the polymer particles contained in the water-based ink ejected from ink-jet nozzles to exhibit a high filling efficiency on prints, resulting in enhanced gloss and image clarity.

In view of not only satisfying the optical density but also preventing clogging of nozzles in a printer and enhancing the dispersion stability, gloss and image clarity, the average particle size of the colorant-containing water-insoluble polymer particles (A) is from 70 to 200 nm, preferably from 80 to 180 nm, more preferably from 90 to 170 nm and still more preferably from 90 to 160 nm, and the average particle size of the colorant-containing water-insoluble polymer particles (B) is from 15 to 110 nm, preferably from 30 to 110 nm, more preferably from 40 to 100 nm and still more preferably from 50 to 90 nm. The average particle size of the polymer particles (A) is larger than that of the polymer particles (B).

Further, to enhance the filling efficiency, the difference between the average particle sizes of the polymer particles (A) and (B) is 10 nm or more, preferably 20 nm or more and more preferably 40 nm or more. However, the difference between the average particle sizes of the polymer particles (A) and (B) is preferably 150 nm or less and more preferably 120 nm or less in view of productivity thereof.

Meanwhile, the average particle size may be measured using a laser particle analyzing system “ELS-8000” (cumulant analysis) available from Otsuka Denshi Co., Ltd. The measurement is conducted at a temperature of 25° C., an angle between incident light and detector of 90° and a cumulative frequency of 100 times, and a refractive index of water (1.333) is input to the analyzing system as a refractive index of the dispersing medium. Upon the above measurement, the concentration of the solution to be measured is usually about 5×10⁻³% by weight.

The method for producing the water dispersion containing the two or more kinds of the water-insoluble polymer particles is not particularly limited. The water dispersion for ink-jet printing can be efficiently produced by mixing at least two kinds of water dispersions respectively containing the colorant-containing polymer particles (A) and the colorant-containing polymer particles (B).

The weight ratio [the polymer particles (A)/the polymer particles (B)] of the polymer particles (A) to the polymer particles (B) in the water dispersion is preferably from 10/90 to 90/10, more preferably from 20/80 to 80/20 and still more preferably from 30/70 to 70/30 in view of enhancing the gloss and image clarity.

To enhance the optical density, gloss, etc., the difference between a content of the colorant in the polymer particles (A) {[(weight of colorant)×100]/(total weight of colorant and water-insoluble polymer)} and a content of the colorant in the polymer particles (B) is preferably 10 or less and more preferably 5 or less.

The polymer particles (A) has D10 (cumulative 10% value in frequency distribution of scattering intensity when the cumulative percentage is calculated sequentially from smaller particles) of preferably 10 nm or more, more preferably 20 nm or more and still more preferably 30 nm or more in view of a good optical density and a facilitated production thereof.

The polymer particles (A) has D50 (cumulative 50% value in frequency distribution of scattering intensity when the cumulative percentage is calculated sequentially from smaller particles) of preferably 210 nm or less, more preferably 190 nm or less and still more preferably 170 nm or less in view of a good storage stability of the resultant water dispersion. The lower limit of D50 of the polymer particles (A) is preferably 10 nm or more in view of a facilitated production thereof.

The polymer particles (A) has D90 (cumulative 90% value in frequency distribution of scattering intensity when the cumulative percentage is calculated sequentially from smaller particles) of preferably 350 nm or less, more preferably 300 nm or less and still more preferably 270 nm or less in view of reducing coarse particles and enhancing a storage stability of the resultant water dispersion. The lower limit of D90 of the polymer particles (A) is preferably 100 nm or more in view of a facilitated production thereof.

The polymer particles (B) has D10 of preferably 5 nm or more, more preferably 10 nm or more, still more preferably 15 nm or more and most preferably 20 nm or more in view of a good optical density and a facilitated production thereof. The upper limit of D10 of the polymer particles (B) is preferably 80 nm or less in view of a facilitated production thereof.

The polymer particles (B) has D50 of preferably 120 nm or less, more preferably 110 nm or less and still more preferably 100 nm or less in view of a good storage stability of the resultant water dispersion. The lower limit of D50 of the polymer particles (B) is preferably 30 nm or more in view of a facilitated production thereof.

The polymer particles (B) has D90 of preferably 230 nm or less, more preferably 210 nm or less and still more preferably 200 nm or less in view of reducing coarse particles and enhancing a storage stability of the resultant water dispersion. The lower limit of D90 of the polymer particles (B) is preferably 50 nm or more in view of a facilitated production thereof.

The D10, D50 and D90 values may be measured by the same method as used for measuring the above average particle size.

When a pigment is used as the colorant, the average primary particle size of the pigment contained in the polymer particles (A) is preferably from 50 to 180 nm, more preferably from 70 to 170 nm and still more preferably from 90 to 160 nm in view of facilitated control of particle size of the polymer particles, a good dispersibility of the pigment, a good optical density, and effective prevention of clogging of nozzles in a printer.

The average primary particle size of the pigment contained in the polymer particles (B) is preferably from 10 to 100 nm, more preferably from 20 to 90 nm and still more preferably from 30 to 80 nm from the same viewpoints as described above.

The average primary particle size of the pigment contained in the polymer particles (A) and the average primary particle size of the pigment contained in the polymer particles (B) may be the same or different from each other.

The average primary particle size of the pigment contained in the respective polymer particles means a number-average particle size which is an average value calculated from particle sizes of 500 particles measured by image analysis using a transmission electron microscope available from Nippon Denshi Co., Ltd. Meanwhile, when the colorant is constituted from particles having a major axis diameter and a minor axis diameter, the average primary particle size is calculated from the major axis diameter.

The water dispersion of the water-insoluble polymer particles may be directly used as a water-based ink using water as a main solvent, and may further contain various additives ordinarily used in water-based inks for ink-jet printing such as wetting agents, penetrants, dispersants, viscosity modifiers, defoaming agents, mildew-proof agents and anti-corrosion agents.

The content (solid content) of the colorant-containing water-insoluble polymer particles in the water dispersion and the water-based ink is preferably controlled to from 0.5 to 30% by weight and more preferably from 1 to 15% by weight in view of a good optical density and a good ejection stability thereof.

The content of the colorant in the water-based ink of the present invention is preferably from 2 to 10% by weight and more preferably from 3 to 8% by weight.

The content of water in the water dispersion and the water-based ink of the present invention is preferably from 30 to 90% by weight and more preferably from 40 to 80% by weight.

The surface tension of the water dispersion of the present invention is preferably from 30 to 65 mN/m and more preferably from 35 to 60 mN/m as measured at 20° C., and the surface tension of the water-based ink of the present invention is preferably from 25 to 50 mN/m and more preferably from 27 to 45 mN/m as measured at 20° C.

The viscosity of the water dispersion of the present invention which has a solid content of 20 wt % is preferably from 1 to 12 mPa·s, more preferably from 1 to 9 mPa·s and still more preferably from 2 to 6 mPa·s as measured at 20° C. to produce a water-based ink having a suitable viscosity.

To adjust the viscosity of the water dispersion of the colorant-containing water-insoluble polymer particles according to the present invention to the above-specified range, the viscosity of each of the water dispersions to be mixed which have a solid content of 20% by weight and contain the water-insoluble polymer particles (A) and (B), respectively, which are different in average particle size from each other, is preferably from 1 to 12 mPa·s, more preferably from 1 to 9 mPa·s and still more preferably from 2 to 6 mPa·s as measured at 20° C.

The viscosity of the water-based ink of the present invention is preferably from 2 to 12 mPa·s, more preferably from 2.5 to 10 mPa·s and still more preferably from 2.5 to 6 mPa·s in view of maintaining a good ejection property thereof. The measurement of the above viscosity may be conducted by the method described in Examples below.

### EXAMPLES

In the following production examples, examples and comparative examples, the “part(s)” and “%” indicate “part(s) by weight” and “% by weight”, respectively, unless otherwise specified. Meanwhile, D10, D50 and D90 are cumulative 10%, 50% and 90% values, respectively, in frequency distribution of scattering intensity when each cumulative percentage is calculated sequentially from the side of smaller particles.

### Production Example 1

Twenty parts of methyl ethyl ketone and 0.03 part of a chain transfer agent (2-mercaptoethanol) together with 10% of total 200 parts of a mixture of respective monomers shown in Table 1 below were charged into a reaction vessel and mixed with each other, and then the reaction vessel was fully purged with a nitrogen gas to thereby obtain a mixed solution.

Separately, remaining 90% of the monomer mixture was charged into a dropping funnel, and further 0.27 part of the chain transfer agent, 60 parts of methyl ethyl ketone and 1.2 parts of a radical polymerization initiator (2,2′-azobis(2,4-dimethylvaleronitrile)) were added thereto and mixed with each other, and the dropping funnel was fully purged with a nitrogen gas to thereby obtain a mixed solution.

The mixed solution in the reaction vessel was heated to 65° C. under stirring in a nitrogen atmosphere, and then the mixed solution in the dropping funnel was gradually dropped thereinto over 3 h. After the elapse of 2 h at 65° C. from completion of the dropping, a solution prepared by dissolving 0.3 part of the radical polymerization initiator in 5 parts of methyl ethyl ketone was added to the above obtained reaction solution, and the resultant solution was aged at 65° C. for 2 h and further at 70° C. for 2 h to obtain a polymer solution.

The weight-average molecular weight of the obtained polymer was measured by the same method as described above. The result is shown in Table 1.

Meanwhile, details of the compounds shown in Table 1 are as follows.

(b) Styrene macromer: “AS-6S” (tradename) available from Toagosei Co., Ltd.; number-average molecular weight: 6000; polymerizable functional group: methacryloyloxy group; a effective content: 50%

(d) Polyethylene glycol monomethacrylate: “NK Ester M-90G” (tradename) available from Shin-Nakamura Kagaku Kogyo Co., Ltd.; molar number of addition of ethyleneoxide: 9 mol in average; terminal: hydrogen atom

(d) Polypropylene glycol monomethacrylate: “Blenmer PP-500” (tradename) available from NOF Corporation; molar number of addition of propyleneoxide: 9 mol in average; terminal: hydrogen atom

TABLE 1

| | Production |
|---|---|
| Kind of Monomer *1 | Example 1 |
| (a) Methacrylic acid | 10 |
| (b) Styrene macromer | 15 |
| (c) Benzyl methacrylate | 40 |
| (c) Styrene monomer | 10 |
| (d) Polyethylene glycol monomethacrylate | 5 |
| (d) Polypropylene glycol monomethacrylate | 20 |
| Weight-average molecular weight | 150,000 |

*1: The numerical values represent respective effective contents (parts by weight) of the monomers.

### Production Example 2

### Production of Water Dispersion A-1

Twenty five parts of the polymer produced by drying the polymer solution obtained in Production Example 1 under reduced pressure was dissolved in 70 parts of methyl ethyl ketone. Further, 4.1 parts of a neutralizing agent (a 5N sodium hydroxide aqueous solution) and 230 parts of ion-exchanged water were added to the resultant solution to neutralize a salt-forming group of the polymer (degree of neutralization: 75%), and then 75 parts of a magenta pigment (C.I. Pigment Red 122 available from Dai-Nippon Ink Co., Ltd.; average primary particle size of the pigment: 130 nm) was added into the reaction solution and mixed with each other at 20° C. for 1 h using disper blades. The thus obtained mixture was dispersed under a pressure of 200 MPa by passing through a dispersing apparatus “MICROFLUIDIZER” (tradename) available from Microfluidics Corp., 10 times.

The resultant dispersion was mixed with 250 parts of ion-exchanged water under stirring, and then methyl ethyl ketone was removed from the resultant mixture under reduced pressure at 60° C., followed by further removing a part of water therefrom. The obtained mixture was filtered through a 5 μm-mesh filter (acetyl cellulose membrane; outer diameter: 2.5 cm; available from Fuji Photo Film Co., Ltd.) fitted to a 25 mL syringe without a needle available from Terumo Co., Ltd., to remove coarse particles therefrom, thereby obtaining a water dispersion A-1 of pigment-containing graft polymer particles a-1 having a solid content of 20%. The average particle size, D10, D50 and D90 of the thus obtained polymer particles a-1 are shown in Table 2.

Also, the viscosity of the water dispersion A-1 was measured using a viscometer “RE80L-Model” (Rotor 1) available from Toki Sangyo Co., Ltd., at a temperature of 20° C. and a rotating speed of 100 rpm. The results are shown in Table 2 together with the weight ratio of the pigment to the water-insoluble polymer in the water dispersion A-1.

### Production Example 3

### Production of Water Dispersion A-2

Twenty five parts of the polymer produced by drying the polymer solution obtained in Production Example 1 under reduced pressure was dissolved in 70 parts of methyl ethyl ketone. Further, 4.2 parts of a neutralizing agent (a 5N sodium hydroxide aqueous solution) and 230 parts of ion-exchanged water were added to the resultant solution to neutralize a salt-forming group of the polymer (degree of neutralization: 60%), and then 75 parts of a cyan pigment (C.I. Pigment Blue 15:4 available from Toyo Ink Seizo Co., Ltd.; average primary particle size of the pigment: 60 nm) was added into the reaction solution and mixed with each other at 20° C. for 1 h using disper blades. The thus obtained mixture was dispersed under a pressure of 200 MPa by passing through a dispersing apparatus “MICROFLUIDIZER” (tradename) available from Microfluidics Corp., 10 times.

The resultant dispersion was treated in the same manner as in Production of the water dispersion A-1, thereby obtaining a water dispersion A-2 of pigment-containing polymer particles a-2 having a solid content of 20%. The average particle size, D10, D50 and D90 of the thus obtained polymer particles a-2 as well as the viscosity of the water dispersion A-2 and the weight ratio of the pigment to the water-insoluble polymer therein are shown in Table 2.

### Production Example 4

### Production of Water Dispersion B-1

Twenty five parts of the polymer produced by drying the polymer solution obtained in Production Example 1 under reduced pressure was dissolved in 70 parts of methyl ethyl ketone. Further, 4.1 parts of a neutralizing agent (a 5N sodium hydroxide aqueous solution) and 230 parts of ion-exchanged water were added to the resultant solution to neutralize a salt-forming group of the polymer (degree of neutralization: 75%), and then 75 parts of a magenta pigment (C.I. Pigment Red 122 available from Clariant Japan Co., Ltd.; average primary particle size of the pigment: 45 nm) was added into the reaction solution and mixed with each other at 20° C. for 1 h using disper blades. The thus obtained mixture was dispersed under a pressure of 200 MPa by passing through a dispersing apparatus “MICROFLUIDIZER” (tradename) available from Microfluidics Corp., 10 times.

The resultant dispersion was treated in the same manner as in Production Example 2, thereby obtaining a water dispersion B-1 of pigment-containing polymer particles b-1 having a solid content of 20%. The average particle size, D10, D50 and D90 of the thus obtained polymer particles b-1 as well as the viscosity of the water dispersion B-1 and the weight ratio of the pigment to the water-insoluble polymer therein are shown in Table 2.

### Production Example 5

### Production of Water Dispersion B-2

Twenty five parts of the polymer produced by drying the polymer solution obtained in Production Example 1 under reduced pressure was dissolved in 45 parts of methyl ethyl ketone. Further, 4.2 parts of a neutralizing agent (a 5N sodium hydroxide aqueous solution) and 115 parts of ion-exchanged water were added to the resultant solution to neutralize a salt-forming group of the polymer (degree of neutralization: 60%), and then 25 parts of a cyan pigment (C.I. Pigment Blue 15:4 available from Toyo Ink Seizo Co., Ltd.; average primary particle size of the pigment: 60 nm) was added into the reaction solution. The resultant mixture was charged together with 1000 parts of zirconia beads having a particle size of 100 μm into a sextuple sand mill apparatus “Model No. 6TSG-¼” available from Igarashi Kikai Seizo Co., Ltd., and dispersed together at a peripheral speed of 10 m/s at 10° C. for 3 h. The thus obtained mixture was dispersed under a pressure of 200 MPa by passing through a dispersing apparatus “MICROFLUIDIZER” (tradename) available from Microfluidics Corp., 20 times.

The resultant dispersion was treated in the same manner as in Production of the water dispersion A-1, thereby obtaining a water dispersion B-2 of pigment-containing graft polymer particles b-2 having a solid content of 20%. The average particle size, D10, D50 and D90 of the thus obtained polymer particles b-2 as well as the viscosity of the water dispersion B-2 and the weight ratio of the pigment to the water-insoluble polymer therein are shown in Table 2.

### Production Example 6

### Production of Water Dispersion B-3

Forty parts of the polymer produced by drying the polymer solution obtained in Production Example 1 under reduced pressure was dissolved in 80 parts of methyl ethyl ketone. Further, 6.6 parts of a neutralizing agent (a 5N sodium hydroxide aqueous solution) and 230 parts of ion-exchanged water were added to the resultant solution to neutralize a salt-forming group of the polymer (degree of neutralization: 60%), and then 60 parts of a cyan pigment (C.I. Pigment Blue 15:4 available from Toyo Ink Seizo Co., Ltd.; average primary particle size of the pigment: 60 nm) was added into the reaction solution. The resultant mixture was charged together with 1000 parts of zirconia beads having a particle size of 100 μm into a sextuple sand mill apparatus “Model No. 6TSG-¼” available from Igarashi Kikai Seizo Co., Ltd., and dispersed together at a peripheral speed of 10 m/s at 10° C. for 3 h. The thus obtained mixture was dispersed under a pressure of 200 MPa by passing through a dispersing apparatus “MICROFLUIDIZER” (tradename) available from Microfluidics Corp., 20 times.

The resultant dispersion was treated in the same manner as in Production of the water dispersion A-1, thereby obtaining a water dispersion B-3 of pigment-containing graft polymer particles b-3 having a solid content of 20%. The average particle size, D10, D50 and D90 of the thus obtained polymer particles b-3 as well as the viscosity of the water dispersion B-3 and the weight ratio of the pigment to the water-insoluble polymer therein are shown in Table 2.

### Production Example 7

### Production of Water Dispersion B-4

Twenty five parts of the polymer produced by drying the polymer solution obtained in Production Example 1 under reduced pressure was dissolved in 70 parts of methyl ethyl ketone. Further, 4.2 parts of a neutralizing agent (a 5N sodium hydroxide aqueous solution) and 230 parts of ion-exchanged water were added to the resultant solution to neutralize a salt-forming group of the polymer (degree of neutralization: 60%), and then 60 parts of a cyan pigment (C.I. Pigment Blue 15:4 available from Toyo Ink Seizo Co., Ltd.; average primary particle size of the pigment: 60 nm) was added into the reaction solution and mixed with each other at 20° C. for 1 h using disper blades. The thus obtained mixture was dispersed under a pressure of 200 MPa by passing through a dispersing apparatus “MICROFLUIDIZER” (tradename) available from Microfluidics Corp., 20 times.

The resultant dispersion was treated in the same manner as in Production of the water dispersion A-1, thereby obtaining a water dispersion B-4 of pigment-containing graft polymer particles b-4 having a solid content of 20%. The average particle size, D10, D50 and D90 of the thus obtained polymer particles b-4 as well as the viscosity of the water dispersion B-4 and the weight ratio of the pigment to the water-insoluble polymer therein are shown in Table 2.

### Production Example 8

### Production of Dispersion C of Water-Soluable Resin

An aqueous solution of “HPD 96” having a solid content of 34% which was available from Johnson Polymer Co., Ltd., and used in an amount of 73.5 parts was added to 190 parts of ion-exchanged water to prepare a dilute solution. Then, 75 parts of a cyan pigment (C.I. Pigment Blue 15:4 available from Toyo Ink Seizo Co., Ltd.; average primary particle size of the pigment: 60 nm) was added into the thus obtained dilute solution and mixed with each other at 20° C. for 1 h using disper blades. The thus obtained mixture was dispersed under a pressure of 200 MPa by passing through a dispersing apparatus “MICROFLUIDIZER” (tradename) available from Microfluidics Corp., 10 times.

The resultant dispersion was treated in the same manner as in Production of the water dispersion A-1, thereby obtaining a dispersion C of the water-soluble resin having a solid content of 20%. The average particle size, D10, D50 and D90 of polymer particles in the thus obtained dispersion C as well as the viscosity of the dispersion C and the weight ratio of the pigment to the water-insoluble polymer therein are shown in Table 2.

### Production Example 9

### Production of Dispersion D of Water-Soluable

### Resin

An aqueous solution of “JOHNCRYL 61J” having a solid content of 31% which was available from Johnson Polymer Co., Ltd., and used in an amount of 161 parts was added to 78 parts of ion-exchanged water to prepare a dilute solution. Then, 50 parts of a magenta pigment (C.I. Pigment Red 122 available from Clariant Japan Co., Ltd.; average primary particle size of the pigment: 45 nm) was added into the thus obtained dilute solution and mixed with each other at 20° C. for 1 h using disper blades. The thus obtained mixture was dispersed under a pressure of 200 MPa by passing through a dispersing apparatus “MICROFLUIDIZER” (tradename) available from Microfluidics Corp., 10 times.

The resultant dispersion was treated in the same manner as in Production of the water dispersion A-1, thereby obtaining a dispersion D of the water-soluble resin having a solid content of 20%. The average particle size, D10, D50 and D90 of polymer particles in the thus obtained dispersion D as well as the viscosity of the dispersion D and the weight ratio of the pigment to the water-insoluble polymer therein are shown in Table 2.

TABLE 2

| | | Average | Average primary | |
|---|---|---|---|---|
| | Polymer | particle size | particle size of | D10 |
| | particles | (nm) | pigment (nm) | (nm) |
| Water | a-1 | 154 | 130 | 90 |
| dispersion A-1 | | | | |
| Water | a-2 | 122 | 60 | 96 |
| dispersion A-2 | | | | |
| Water | b-1 | 82 | 45 | 51 |
| dispersion B-1 | | | | |
| Water | b-2 | 54 | 60 | 30 |
| dispersion B-2 | | | | |
| Water | b-3 | 69 | 60 | 45 |
| dispersion B-3 | | | | |
| Water | b-4 | 85 | 60 | 56 |
| dispersion B-4 | | | | |

| | | | |
|---|---|---|---|
| Dispersion C of | 104 | 60 | 53 |
| water-soluble resin | | | |
| Dispersion D of | 58 | 45 | 30 |
| water-soluble resin | | | |

| | D50 | D90 | Viscosity | Weight ratio of |
|---|---|---|---|---|
| | (nm) | (nm) | (mPa · s) | pigment to polymer |
| Water dispersion | 141 | 241 | 3.0 | 75/25 |
| A-1 | | | | |
| Water dispersion | 132 | 179 | 2.8 | 75/25 |
| A-2 | | | | |
| Water dispersion | 80 | 134 | 5.0 | 75/25 |
| B-1 | | | | |
| Water dispersion | 57 | 103 | 5.7 | 50/50 |
| B-2 | | | | |
| Water dispersion | 77 | 117 | 8.7 | 60/40 |
| B-3 | | | | |
| Water dispersion | 83 | 131 | 3.8 | 75/25 |
| B-4 | | | | |
| Dispersion C of | 117 | 226 | 18.5 | 75/25 |
| water-soluble resin | | | | |
| Dispersion D of | 60 | 140 | 120 | 50/50 |
| water-soluble resin | | | | |

### Example 1

Thirty parts of the water dispersion A-1 produced in Production Example 2, 10 parts of the water dispersion B-1 produced in Production Example 4 and 1 part of dibutyl sebacate were mixed with each other under stirring. The resultant mixed solution was mixed with 10 parts of glycerol, 7 parts of triethylene glycol monobutyl ether (TEGMBE; as a penetrant), 1 part of “SURFYNOL 465” (as a surfactant) available from Avecia KK, 0.3 part of “Ploxel XL2” (as a preservative) available from ZENECA Co., Ltd., and 40.7 parts of ion-exchanged water, and the resultant mixed solution was filtered through a 1.2 μm-mesh filter (acetyl cellulose membrane; outer diameter: 2.5 cm; available from Fuji Photo Film Co., Ltd.) fitted to a 25 mL syringe without a needle to remove coarse particles therefrom, thereby obtaining a water-based ink as shown in Table 2.

Further, the viscosity of a mixture composed of 30 parts of the water dispersion A-1 produced in Production Example 2 and 10 parts of the water dispersion B-1 produced in Production Example 4 was measured. As a result, it was confirmed that the viscosity of the mixed dispersion was 3.3 mPa·s, and was lower than 3.5 mPa·s as a weighted average of respective viscosity values of the water dispersions A-1 and B-1.

### Example 2

Twenty parts of the water dispersion A-1 produced in Production Example 2, 20 parts of the water dispersion B-1 produced in Production Example 4 and 1 part of dibutyl sebacate were mixed with each other under stirring. Thereafter, the resultant mixed solution was treated in the same manner as in Example 1, thereby obtaining a water-based ink as shown in Table 3.

Further, the viscosity of a mixture composed of 20 parts of the water dispersion A-1 produced in Production Example 2 and 20 parts of the water dispersion B-1 produced in Production Example 4 was measured. As a result, it was confirmed that the viscosity of the mixed dispersion was 3.6 mPa·s, and was lower than 4.0 mPa·s as a weighted average of respective viscosity values of the water dispersions A-1 and B-1.

### Example 3

Twenty five parts of the water dispersion A-2 produced in Production Example 3, 12.5 parts of the water dispersion B-2 produced in Production Example 5 and 1 part of dibutyl sebacate were mixed with each other under stirring. Thereafter, the resultant mixed solution was treated in the same manner as in Example 1, thereby obtaining a water-based ink as shown in Table 3.

### Example 4

Twenty five parts of the water dispersion A-2 produced in Production Example 3, 10.4 parts of the water dispersion B-3 produced in Production Example 6 and 1 part of dibutyl sebacate were mixed with each other under stirring. Thereafter, the resultant mixed solution was treated in the same manner as in Example 1, thereby obtaining a water-based ink as shown in Table 3.

### Example 5

Twenty five parts of the water dispersion A-2 produced in Production Example 3, 8.3 parts of the water dispersion B-4 produced in Production Example 7 and 1 part of dibutyl sebacate were mixed with each other under stirring. Thereafter, the resultant mixed solution was treated in the same manner as in Example 1, thereby obtaining a water-based ink as shown in Table 3.

### Comparative Example 1

Forty parts of the water dispersion A-1 produced in Production Example 2 and 1 part of dibutyl sebacate were mixed with each other under stirring. Thereafter, the resultant mixed solution was treated in the same manner as in Example 1, thereby obtaining a water-based ink as shown in Table 3.

### Comparative Example 2

The water dispersion A-2 produced in Production Example 3 which was used in an amount of 33.3 parts and 1 part of dibutyl sebacate were mixed with each other under stirring. Thereafter, the resultant mixed solution was treated in the same manner as in Example 1, thereby obtaining a water-based ink as shown in Table 3.

### Comparative Example 3

Forty parts of the water dispersion B-1 produced in Production Example 4 and 1 part of dibutyl sebacate were mixed with each other under stirring. Thereafter, the resultant mixed solution was treated in the same manner as in Example 1, thereby obtaining a water-based ink as shown in Table 3.

### Comparative Example 4

Fifty parts of the water dispersion B-2 produced in Production Example 5 and 1 part of dibutyl sebacate were mixed with each other under stirring. Thereafter, the resultant mixed solution was treated in the same manner as in Example 1, thereby obtaining a water-based ink as shown in Table 3.

### Comparative Example 5

The water dispersion B-3 produced in Production Example 6 which was used in an amount of 41.7 parts, and 1 part of dibutyl sebacate were mixed with each other under stirring. Thereafter, the resultant mixed solution was treated in the same manner as in Example 1, thereby obtaining a water-based ink as shown in Table 3.

### Comparative Example 6

The water dispersion B-4 produced in Production Example 7 which was used in an amount of 33.3 parts, and 1 part of dibutyl sebacate were mixed with each other under stirring. Thereafter, the resultant mixed solution was treated in the same manner as in Example 1, thereby obtaining a water-based ink as shown in Table 3.

### Comparative Example 7

The water dispersion C produced in Production Example 8 which was used in an amount of 33.3 parts, and 1 part of dibutyl sebacate were mixed with each other under stirring. Thereafter, the resultant mixed solution was treated in the same manner as in Example 1, thereby obtaining a water-based ink as shown in Table 3.

### Comparative Example 8

Sixty parts of the water dispersion D produced in Production Example 9 and 1 part of dibutyl sebacate were mixed with each other under stirring. Thereafter, the resultant mixed solution was treated in the same manner as in Example 1, thereby obtaining a water-based ink as shown in Table 3.

When the water dispersion C produced in Production Example 8 and the water dispersion D produced in Production Example 9 were mixed with each other, it was confirmed that the viscosity of the resultant mixture was not lower than a weighted average of respective viscosity values of the water dispersions C and D.

The properties of the water-based inks obtained in the above Examples and Comparative Examples were measured by the following methods. The results are shown in Table 2.

### (1) Optical Density

Solid image printing was carried out on a printing paper available from Xerox Corp., using an ink-jet printer “Model EM930C” (piezoelectric type) available from Seiko Epson Co., Ltd., under the following printing conditions:

Kind of Paper: Ordinary Paper

Mode set: Photo.

After allowing the printed paper to stand at 25° C. for 24 h, the optical density thereof was measured 5 times using a Macbeth densitometer “RD914” (product number) available from Gretag-Macbeth Corp., to calculate an average of the measured values.

(2) Gloss

Solid image printing was carried out on a coated paper (photographic paper <glossy> “KA450PSK (tradename)” having a 60° gloss of 41 which was available from Seiko Epson Co., Ltd., using the above ink-jet printer under the following printing conditions:

Kind of Paper: Photo Printing Paper; and

Mode set: Photo.

After allowing the printed paper to stand at 25° C. for 24 h, the 20° gloss thereof was measured 5 times using a glossmeter “HANDY GLOSSMETER” (tradename; product number: PG-1) available from Nippon Denshoku Industries Co., Ltd., to calculate an average of the measured values.

### (3) Image Clarity

Solid image printing was carried out on the same commercially available coated paper as used in the above (2) using the above ink-jet printer such that the printed area ratio was 100% (using a magenta colorant whose RGB (red/green/blue) values were R: 255; G: 0; B: 255 in Examples 1 and 2 and Comparative Examples 1 and 3; and using a cyan colorant whose RGB values were R: 0; G: 255; B: 255 in Examples 3 to 5 and Comparative Examples 2 and 4 to 6), and the printed area ratio was 50% (using a cyan colorant whose RGB values were R: 128; G: 255; B: 255 in Examples 3 to 5 and Comparative Examples 2 and 4 to 6). After allowing the printed paper to stand at 25° C. for 24 h, the 45° image clarity C value (comb width: 2.0 mm) was measured 3 times using an image clarity measuring apparatus “Touch Panel-Type Image Clarity Meter (tradename)” (product number: ICM-IT) available from Suga Testing Machine Co., Ltd., to calculate an average of the measured values.

The “image clarity” used herein means a measured value for a clearness or distortion of images reflected on the print. The larger the image clarity value, the more excellent the clearness of images reflected and the less the distortion of images reflected became, so that the images reflected were observed more naturally.

TABLE 3

| | Examples | | | | |
|---|---|---|---|---|---|
| | 1 | 2 | 3 | 4 | 5 |
| Dispersion (wt %) | | | | | |
| A-1 (average particle size: 154 nm) | 30 | 20 | | | |
| A-2 (average particle size: 122 nm) | | | 25 | 25 | 25 |
| B-1 (average particle size: 82 nm) | 10 | 20 | | | |
| B-2 (average particle size: 54 nm) | | | 12.5 | | |
| B-3 (average particle size: 69 nm) | | | | 10.4 | |
| B-4 (average particle size: 85 nm) | | | | | 8.3 |
| C (average particle size: 104 nm) | | | | | |
| D (average particle size: 58 nm) | | | | | |
| Polymer particles (ratio A/B) | 3/1 | 1/1 | 2/1 | 2.4/1 | 3/1 |
| Composition of ink | | | | | |
| Solid content of water dispersion | 8 | 8 | 7.5 | 7.1 | 6.7 |
| Dibutyl sebacate | 1 | 1 | 1 | 1 | 1 |
| Glycerol | 10 | 10 | 10 | 10 | 10 |
| TEGMBE | 7 | 7 | 7 | 7 | 7 |
| SURFYNOL 465 | 1 | 1 | 1 | 1 | 1 |
| Ploxel XL2 | 0.3 | 0.3 | 0.3 | 0.3 | 0.3 |
| Ion-exchanged water | 72.7 | 72.7 | 73.2 | 73.6 | 74.0 |
| Evaluation of performance | | | | | |
| Optical density | 1.03 | 1.03 | 1.07 | 1.07 | 1.08 |
| 60° Gloss | 47 | 49 | 94 | 95 | 100 |
| Image clarity 1 (printed area ratio: | 34 | 33 | 50 | 53 | 58 |
| 100%) | | | | | |
| Image clarity 2 (printed area ratio: | | | 34 | 38 | 40 |
| 50%) | | | | | |

| | Comparative Examples | | | |
|---|---|---|---|---|
| | 1 | 2 | 3 | 4 |
| Dispersion (wt %) | | | | |
| A-1 (average particle size: 154 nm) | 40 | | | |
| A-2 (average particle size: 122 nm) | | 33.3 | | |
| B-1 (average particle size: 82 nm) | | | 40 | |
| B-2 (average particle size: 54 nm) | | | | 50 |
| B-3 (average particle size: 69 nm) | | | | |
| B-4 (average particle size: 85 nm) | | | | |
| C (average particle size: 104 nm) | | | | |
| D (average particle size: 58 nm) | | | | |
| Polymer particles (ratio A/B) | — | — | — | — |
| Composition of ink | | | | |
| Solid content of water dispersion | 8 | 6.7 | 8 | 10 |
| Dibutyl sebacate | 1 | 1 | 1 | 1 |
| Glycerol | 10 | 10 | 10 | 10 |
| TEGMBE | 7 | 7 | 7 | 7 |
| SURFYNOL 465 | 1 | 1 | 1 | 1 |
| Ploxel XL2 | 0.3 | 0.3 | 0.3 | 0.3 |
| Ion-exchanged water | 72.7 | 74.0 | 72.7 | 70.7 |
| Evaluation of performance | | | | |
| Optical density | 1.03 | 1.07 | 1.03 | 1.02 |
| 60° Gloss | 39 | 90 | 27 | 94 |
| Image clarity 1 (printed area ratio: | 27 | 54 | 17 | 40 |
| 100%) | | | | |
| Image clarity 2 (printed area ratio: | | 37 | | 24 |
| 50%) | | | | |
| | Comparative Examples | | | |
| | 5 | 6 | 7 | 8 |
| Dispersion (wt %) | | | | |
| A-1 (average particle size: 154 nm) | | | | |
| A-2 (average particle size: 122 nm) | | | | |
| B-1 (average particle size: 82 nm) | | | | |
| B-2 (average particle size: 54 nm) | | | | |
| B-3 (average particle size: 69 nm) | 41.7 | | | |
| B-4 (average particle size: 85 nm) | | 33.3 | | |
| C (average particle size: 104 nm) | | | 33.3 | |
| D (average particle size: 58 nm) | | | | 60 |
| Polymer particles (ratio A/B) | — | — | — | — |
| Composition of ink | | | | |
| Solid content of water dispersion | 8.3 | 6.7 | 6.7 | 12 |
| Dibutyl sebacate | 1 | 1 | 1 | 1 |
| Glycerol | 10 | 10 | 10 | 10 |
| TEGMBE | 7 | 7 | 7 | 7 |
| SURFYNOL 465 | 1 | 1 | 1 | 1 |
| Ploxel XL2 | 0.3 | 0.3 | 0.3 | 0.3 |
| Ion-exchanged water | 72.4 | 74.0 | 74.0 | 68.7 |
| Evaluation of performance | | | | |
| Optical density | 1.00 | 1.06 | — | — |
| 60° Gloss | 96 | 101 | — | — |
| Image clarity 1 (printed area ratio: | 46 | 54 | — | — |
| 100%) | | | | |
| Image clarity 2 (printed area ratio: | 30 | 31 | — | — |
| 50%) | | | | |

From the results shown in Tables 2 and 3, it was confirmed that the water-based inks for inkjet printing obtained in Examples were excellent in optical density upon printing on an ordinary paper, and gloss and image clarity upon printing on a coated paper.

Further, it was confirmed that the water-based ink for ink-jet printing according to the present invention was also excellent in rubbing resistance, and the water dispersion for ink-jet printing according to the present invention was reduced in viscosity thereof, exhibited an advantageous ejecting property, and enabled the colorant to be blended in the water-based ink at a high concentration. On the other hand, in Comparative Examples, the resultant dispersions and inks were deteriorated in balance between optical density, gloss and image clarity, in particular, in Comparative Examples 7 and 8, the viscosity of the resultant inks was too high to suitably eject the inks through ink-jet nozzles.

### INDUSTRIAL APPLICABILITY

The water-based ink containing the water dispersion for ink-jet printing according to the present invention in which colorant-containing water-insoluble polymer particles are dispersed, exhibits not only a high optical density but also excellent gloss and image clarity upon printing on coated papers.

In accordance with the production process of the present invention, the water dispersion for ink-jet printing as well as the water-based ink can be produced in an efficient manner.

1. A water dispersion for ink-jet printing comprising colorant-containing water-insoluble polymer particles which is obtainable by mixing at least two kinds of water-insoluble polymer particles (A) and (B) which are different in average particle size from each other, wherein said polymer particles (A) have an average particle size of 70 to 200 nm and said polymer particles (B) have an average particle size of 15 to 110 nm with the proviso that the average particle size of the polymer particles (A) is larger than that of the polymer particles (B), and a difference between the average particle sizes of the polymer particles (A) and (B) is 10 nm or more.

2. The water dispersion for ink-jet printing according to claim 1, wherein a weight ratio of the polymer particles (A) to the polymer particles (B) is from 10/90 to 90/10.

3. The water dispersion for ink-jet printing according to claim 1, wherein a weight ratio of the colorant to the water-insoluble polymer in the colorant-containing water-insoluble polymer particles is from 50/50 to 90/10.

4. The water dispersion for ink-jet printing according to claim 1, wherein the colorant is a pigment, and the pigment contained in the polymer particles (A) has an average primary particle size of 50 to 180 nm, and the pigment contained in the polymer particles (B) has an average primary particle size of 10 to 100 nm.

5. The water dispersion for ink-jet printing according to claim 1, wherein the water-insoluble polymer is a water-insoluble graft polymer containing a constitutional unit derived from a macromer.

6. The water dispersion for ink-jet printing according to claim 1, wherein the water-insoluble polymer has a weight-average molecular weight of 5,000 to 500,000.

7. The water dispersion for ink-jet printing according to claim 1, wherein the polymer particles (A) has D50 (cumulative 50% value in frequency distribution of scattering intensity when the cumulative percentage is calculated sequentially from smaller particles) of 210 nm or less and D90 (cumulative 90% value in frequency distribution of scattering intensity when the cumulative percentage is calculated sequentially from smaller particles) of 350 nm or less, and the polymer particles (B) has D50 of 120 nm or less and D90 of 230 nm or less.

8. The water dispersion for ink-jet printing according to claim 1, wherein the colorant is a chromatic pigment.

9. The water dispersion for ink-jet printing according to claim 1, wherein the water dispersion having a solid content of 20% had a viscosity of from 1 to 12 mPa·s as measured at 20° C.

10. The water dispersion for ink-jet printing according claim 1, further comprising a water-insoluble organic compound.

11. A water-based ink for ink-jet printing comprising the water dispersion as defined in claim 1.

12. A process for producing a water dispersion for in jet printing comprising the step of mixing at least two kinds of water dispersions containing colorant-containing water-insoluble polymer particles, wherein water-insoluble polymer particles (A) contained in the first water dispersion have an average particle size of 70 to 200 nm and water-insoluble polymer particles (B) contained the second water dispersion have an average particle size of 15 to 110 nm with the proviso that the average particle size of the polymer particles (A) is larger than that of the polymer particles (B), and a difference between the average particle sizes of the polymer particles (A) and (B) is 10 nm or more.

13. A water-based ink for ink-jet printing comprising the water dispersion produced by the process as defined in claim 12.
